(19) United States
(12) Patent Application Publication
(10) Pub. No.: US 2005/0096772 A1
(43) Pub. Date: May 5, 2005

(54) Transformer performance prediction

(76) Inventors: David N. Cox, Raleigh, NC (US); Thomas E. Long, Wake Forest, NC (US); Karen J. Smiley, Benson, NC (US); John C. Sutton, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/699,467

(22) Filed: Oct. 31, 2003

(51) Int. Cl. G06G 7/00; G06F 15/18; G06F 19/00; G06F 11/30; G06F 15/00; G21C 17/00

(52) U.S. Cl. 700/104; 700/108; 702/182

(57) ABSTRACT

A method for predicting transformer performance includes receiving information representative of a plurality of built transformers, the information comprising a design specification for each built transformer, and measured test information for each built transformer, receiving a second transformer design specification, and determining, via an intelligent system, a predicted test result for the second transformer design specification based on the second transformer design specification and the information representative of the plurality of built transformers.

### CROSS-REFERENCE TO RELATED APPLICATIONS

This application is related to co-pending patent application Ser. No.______, filed concurrently on Oct. 31, 2003, entitled “Transformer Testing” (Attorney Docket: ABDT-0578/B030100), which is hereby incorporated by reference in its entirety. This application is related to co-pending patent application Ser. No.______, filed concurrently on Oct. 31, 2003, entitled “Method for Generating and Using a Transformer Model” (Attorney Docket: ABDT-0581/B030090), which is hereby incorporated by reference in its entirety. This application is related to co-pending patent application Ser. No.______, filed concurrently on Oct. 31, 2003, entitled “Method for Evaluating a Transformer Design” (Attorney Docket: ABDT-0582/B030080), which is hereby incorporated by reference in its entirety.

### FIELD OF THE INVENTION

The invention relates generally to predicting transformer performance, and more particularly to using an intelligent system to predict transformer performance based on the design of the transformer and test results of previously built transformers.

### BACKGROUND OF THE INVENTION

Energy companies provide power to consumers via power generation units. A power generation unit may be a coal-fired power plant, a hydroelectric power plant, a gas turbine and a generator, a diesel engine and a generator, a nuclear power plant, and the like. The power is transmitted to consumers via a transmission and distribution system that may include power lines, power transformers, protective switches, sectionalizing switches, other switches, breakers, reclosers, and the like. The transmission and distribution system forms at least one, and possibly more, electrical paths between the generation units and power customers (e.g., homes, businesses, offices, street lights, and the like).

Power transformers play an important role in the transmission and distribution of power. Power transformers may convert between the high-voltage used for power transmission and the medium-voltage used for power distribution to homes, offices, and the like. As such, power transformers form a critical link in the supply of power to customers. Failure of a power transformer often means power loss to a number of customers. A failure of a large substation power transformer may mean power loss to a large number of customers while failure of a small pole-mounted power transformer may mean power loss to a single house. In any event, electric utilities typically desire reliable transformers to reduce the amount of power losses to customers.

In addition to transformer reliability, electric utilities are typically very concerned with power transformer cost and efficiency. While the initial purchase cost is generally an important consideration in any purchase, power transformers also have annual costs to run the transformer due to internal losses associated with each transformer. Because electric utilities cannot directly charge customers for these losses, the utilities typically specify efficient power transformers. Moreover, electric utilities often negotiate a contractual financial penalty from transformer manufacturers if a transformer does not meet the specified efficiency.

To meet this market demand, transformer manufacturers attempt to design reliable and efficient power transformers. Power transformer design, however, is a very complex process. There are hundreds of design parameters that affect the cost and performance (e.g., reliability, efficiency, etc.) of a transformer. Conventional techniques for analyzing the relationship between the design parameters and transformer performance focus on theoretical relationships between them. For example, it is known that eddy current losses vary proportionately to the square of the product of frequency, flux density, and lamination thickness. In reality, however, many other design parameters may affect the eddy current losses. Many of these relationships have probably not yet been discovered. Conventional techniques do not address the effect of these other design parameters and the unknown relationships between parameters.

Thus, there is a need for systems, methods, and the like, for predicting transformer performance without relying on theoretical relationships.

### SUMMARY OF THE INVENTION

A method for predicting transformer performance includes receiving information representative of a plurality of built transformers, the information comprising a design specification for each built transformer, and measured test information for each built transformer, receiving a second transformer design specification, and determining, via an intelligent system, a predicted test result for the second transformer design specification based on the second transformer design specification and the information representative of the plurality of built transformers.

The intelligent system may include a neural network, a genetic algorithm, fuzzy logic, or the like. The second transformer design specification may be received from a user interface. The information representative of a plurality of built transformers may include manufacture information for each built transformer and as-built information for each built transformer.

The method may also include receiving a manufacturing specification for the second transformer design, and determining the predicted result may include determining a predicted test result for the second transformer design specification based on the second transformer design specification, the information representative of the plurality of built transformers, and the manufacturing specification for the second transformer design.

A system for predicting transformer performance includes a data store and an intelligent system in communication with the data store. The data store includes information representative of a plurality of built transformers, the information comprising a design specification for each built transformer and measured test information for each built transformer. The intelligent system is configured to perform receiving a second transformer design specification and determining a predicted test result for the transformer design based on the second transformer design specification and the information representative of the plurality of built transformers.

The intelligent system may include a neural network, a genetic algorithm, fuzzy logic, or the like. The system may include a user interface in communication with the intelligent system that receives the second transformer design specification. The information representative of a plurality of built transformers may also include manufacture information for each built transformer and as-built information for each built transformer.

The intelligent system may also perform receiving a manufacturing specification for the second transformer design, and determining the predicted result may include determining a predicted test result for the second transformer design specification based on the second transformer design specification, the information representative of the plurality of built transformers, and the manufacturing specification for the second transformer design.

### BRIEF DESCRIPTION OF THE DRAWINGS

Systems and methods for predicting transformer performance are further described with reference to the accompanying drawings in which:

FIG. 1 is a diagram of an exemplary computing environment and an illustrative system for predicting transformer performance, in accordance with an embodiment of the invention;

FIG. 2 is a diagram of an exemplary computing network environment and an illustrative system for predicting transformer performance, in accordance with an embodiment of the invention;

FIG. 3 is a diagram of an illustrative system for predicting transformer performance, illustrating further details of the system of FIG. 1, in accordance with an embodiment of the invention;

FIG. 4 is a flow diagram of an illustrative method for predicting transformer performance, in accordance with an embodiment of the invention.

### DETAILED DESCRIPTION OF ILLUSTRATIVE EMBODIMENTS

Transformer performance is predicted using an intelligent system based on a transformer design and test results of previously built transformers. Systems and methods for predicting transformer performance may be implemented in one or more of the exemplary computing environments described in more detail below, or in other computing environments.

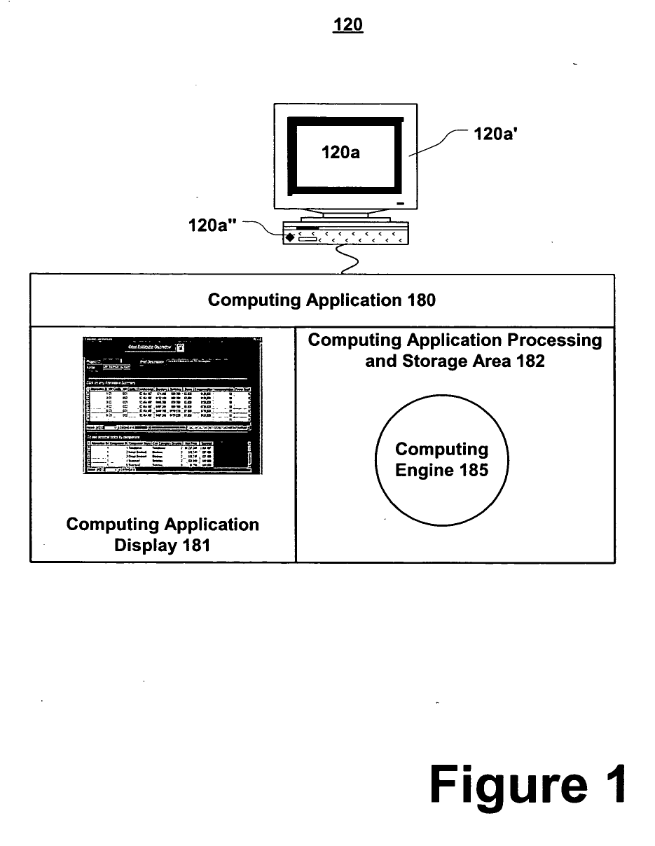

FIG. 1 shows computing system 120 that includes computer 120a. Computer 120a includes display device 120a′ and interface and processing unit 120a″. Computer 120a executes computing application 180. As shown, computing application 180 includes a computing application processing and storage area 182 and a computing application display 181. Computing application processing and storage area 182 includes computing engine 185. Computing engine 185 may implement systems and methods for predicting transformer performance. Computing application display 181 may include display content which may be used for predicting transformer performance for assistance with designing and manufacturing transformers. In operation, a user (not shown) may interface with computing application 180 through computer 120a. The user may navigate through computing application 180 to input, display, and generate data and information for predicting transformer performance.

Computing application 180 may generate a predicted transformer performance, such as, for example, a predicted load loss, a predicted run temperature, and the like. The predicted information may be displayed to the user as display content via computing application display 181.

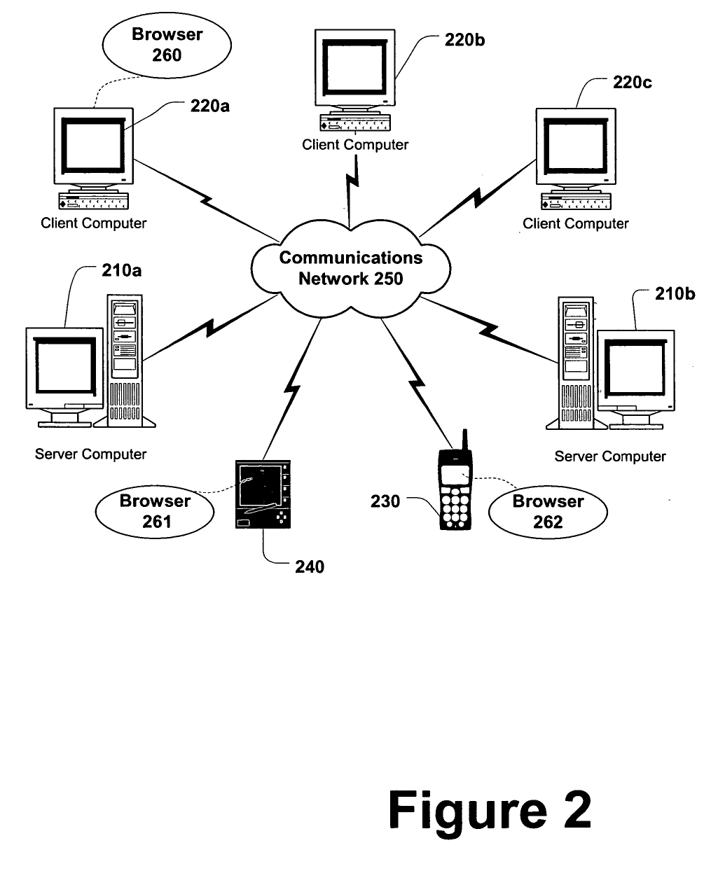

Computer 120a, described above, can be deployed as part of a computer network. In general, the description for computers may apply to both server computers and client computers deployed in a network environment. FIG. 2 illustrates an exemplary network environment having server computers in communication with client computers, in which systems and methods for predicting transformer performance may be implemented. As shown in FIG. 2, a number of server computers 210a, 210b, etc., are interconnected via a communications network 250 with a number of client computers 220a, 220b, 220c, etc., or other computing devices, such as, a mobile phone 230, and a personal digital assistant 240. Communication network 250 may be a wireless network, a fixed-wire network, a local area network (LAN), a wide area network (WAN), an intranet, an extranet, the Internet, or the like. In a network environment in which the communications network 250 is the Internet, for example, server computers 210 can be Web servers with which client computers 220 communicate via any of a number of known communication protocols, such as, hypertext transfer protocol (HTTP), wireless application protocol (WAP), and the like. Each client computer 220 can be equipped with a browser 260 to communicate with server computers 210. Similarly, personal digital assistant 240 can be equipped with a browser 261 and mobile phone 230 can be equipped with a browser 262 to display and communicate data and information.

In operation, the user may interact with computing application 180 to generate prediction on transformer performance, as described above. The predicted transformer performance may be stored on server computers 210, client computers 220, or other client computing devices. The predicted transformer performance may be communicated to users via client computing devices, client computers 220, or the like.

Thus, the systems and methods for predicting transformer performance can be implemented and used in a computer network environment having client computing devices for accessing and interacting with the network and a server computer for interacting with client computers. The systems and methods can be implemented with a variety of network-based and standalone architectures, and thus should not be limited to the examples shown.

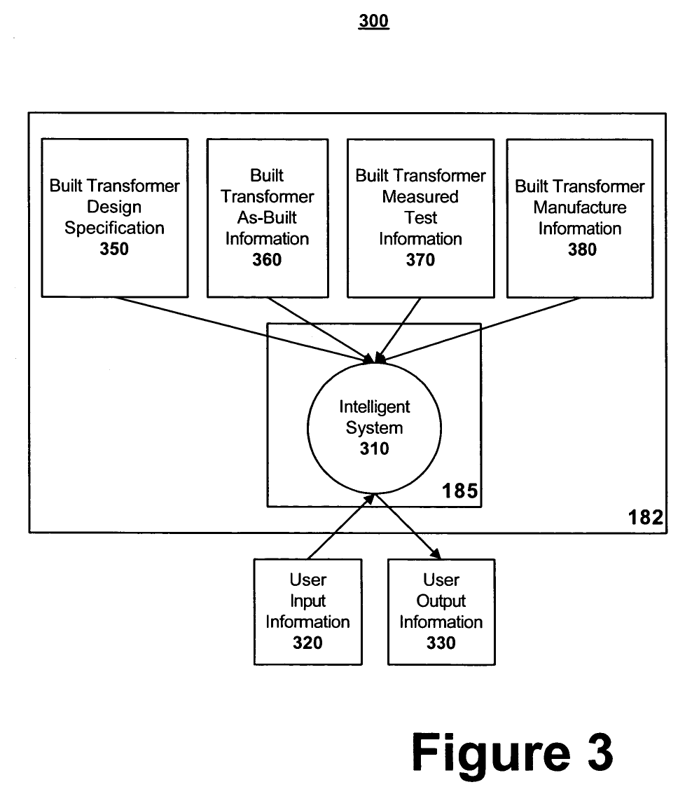

FIG. 3 shows an illustrative system 300 for predicting transformer performance. As shown in FIG. 3, system 300 may include computing application processing and storage area 182, user input information 320, and user output information 330. Computing application processing and storage area 182 may include computing engine 185. While computing engine 185 is shown as being implemented in a single engine, computing engine 185 may be implemented in any number of engines. Further, the various functionalities of computing engine 185 may be distributed among various engines in any convenient fashion.

Computing engine 185 may include an intelligent system 310. Intelligent system 310 may include a neural network, a genetic algorithm, fuzzy logic, an algorithm that performs a non-linear regression and the like. The intelligent system 310 may process a selected set of design (and/or as-built) parameters and test results to determine correlations. A neural network is a modeling technique based on the observed behavior of biological neurons and used to mimic the performance of a system (e.g., a power transformer). The neural network may include a set of elements that start out connected in a random pattern, and, based upon operational feedback, are molded into a pattern used to generate results that effectively models the system. Typically, a neural network is “trained” with a series of examples. For example, the neural network may receive transformer design specification information for a built transformer and corresponding measured test results of built transformers during training of the neural network. After a sufficient number of examples are received by the neural network, the neural network may develop a network model that mimics a transformer output transformer performance parameters. As-built transformer information may also be input into the neural network to further refine the network model. Additionally, manufacture information for a built transformer may be input to the model to still further refine the network model. These same parameters may be used in intelligent system 310, regardless of the type of intelligent system implemented.

In contrast to a neural network, a genetic algorithm uses mutation and replication to produce additional algorithms that represent the survival of the fittest algorithms. The algorithms that best model the system (e.g., a transformer) survive the longest and eventually become the selected model. For example, the genetic algorithm may receive transformer design specification information for a built transformer and corresponding measured test results of built transformers. The algorithms will mutate and replicate until an algorithm is found that ‘best’ models a transformer. Additional input may cause the algorithms to again mutate and replicate, thereby further refining the algorithm and the model. The genetic algorithm may output transformer performance parameters and degrees of error representative of the quality of the algorithm. One embodiment of intelligent system 310 may include a neural network backpropagation algorithm and may include a commercially available neural network software program.

Fuzzy logic is a mathematical technique for dealing with imprecise data and problems that have many solutions rather than one. Although fuzzy logic may be implemented in digital computers (which are typically binary systems), fuzzy logic works with ranges of values, solving problems in a way that more resembles human logic. Fuzzy logic may be used for solving problems with expert systems and real-time systems that react to an imperfect environment of highly variable, volatile or unpredictable conditions. Fuzzy logic expands on traditional set theory by making membership in a set a matter of degree rather than a yes-no situation.

Various information 350-380 may be input into intelligent system 310. The information 350-380 may be stored in computing application processing and storage area 182, as shown. Alternatively, information 350-380 may be stored in client computer 220a, server computer 210a, or the like. Information 350-380 may be stored in any convenient manner, such as, for example, in a multidimensional database, a relational database, tables, data structures, an analytical database, an operational database, a hybrid database, a text file, and the like.

As shown in FIG. 3, intelligent system 310 may be in communication with built transformer design specification information 350, built transformer as-built information 360, built transformer measured test information 370, and built transformer manufacture information 380. Built transformer design specification information 350, includes information representative of the design parameters of the built transformer. For example, built transformer design specification information 350 may include, for example, the designed power rating of the built transformer, the specifications of the conductor that was designed to be used in the transformer, the specifications of the core that was designed to be used in the transformer, dimensions found on engineering drawings (e.g., lengths, widths, and thicknesses of the various parts of a transformer), the number of layers of metal and insulating material in the core, the type of insulating material, the total weight of the core, the amount and type of oil, special instructions like how much torque to use to tighten bolts, and the like. Alternatively, intelligent system 310 may receive an indication of a power transformer design type, and an indication of a power transformer design revision, and the like. In such an alternative embodiment, intelligent system 310 may communicate with a database containing the built transformer design specification information based on the indication of design type, design revision, and the like. In this manner, less data storage may be occupied by built transformer design specification information 350.

Built transformer as-built information 360 includes information representative of the as-built parameters (which may or may not be the same as the design specification) of the built transformer. For example, built transformer as-built information 360 may include the specifications of the actual conductor that was installed in the transformer, the specification of the actual core that was installed in the transformer, lot numbers of all materials used in the manufacture of a transformer, the names of the suppliers, the cost of the materials, the results of any quality control tests performed on those materials (e.g., the measure of specific gravity of the oil used in a transformer), and the like.

Built transformer measured test information 370 includes information representative of information measured from tests of the built transformer. For example, built transformer measured test information 370 may include, for example, a load loss measured from the built transformer, a temperature measured from the built transformer, the results of an impulse test measured from the built transformer, pressure rise, oil rise, top of unit oil temperature, top oil temperature, top oil rise, top oil measured, average oil rise, max oil rise, gradient temperature at tested current, average duct temperature rise, winding temperature rise, resistance, ratio, polarity, instrumentation loss, shorting bar loss, impedance, eddies and strays, root-mean-square (rms) amps, rms watts, voltage, and the like. Many of these measurements may be made several times with the transformer exposed to different conditions (e.g., different ambient temperatures, different applied current, etc.). The measured test information may include actual measured values and values determined from the actual measured values.

Built transformer manufacture information 380 includes information representative of the manufacture of the built transformer. For example, built transformer manufacture information 380 may include an indication of a winding machine used in the manufacture of the built transformer, an indication of the last date and time that the winding machine was calibrated, an indication of a core cutting machine used in the manufacture of the built transformer, an indication of the last date and time that the cutting machine was retooled, environmental parameters experienced during manufacture (e.g., barometric pressure, temperature, and humidity), and the like.

Based on information 350-380, intelligent system 310 creates a model of a transformer, as described above. Based on that model, intelligent system 310 may output a predicted transformer performance parameter for a user-specified transformer design specification. To interface with a user and receive a transformer design, intelligent system 310 may receive user input information 320. User input information 320 may include information input by a user into interface and processing unit 120a″, browsers 260-262, and the like. User input information 320 includes power transformer design information, such as, for example, an indication of a particular conductor, specification of a conductor, and the like. User input information 320 may also include power transformer manufacture information, such as, for example, a particular winding machine to wind the core, and the like. User output information 330 includes predicted performance results for the user-input information, such as, for example, a predicted load loss, and the like. In this manner, a user can perform “what-if” analysis on transformer designs. Moreover, a user can perform “what-if” analysis on transformer designs and may determine the effect of building the power transformer at different manufacturing plants, on different manufacturing machines, with different manufacturing equipment calibration dates, and the like.

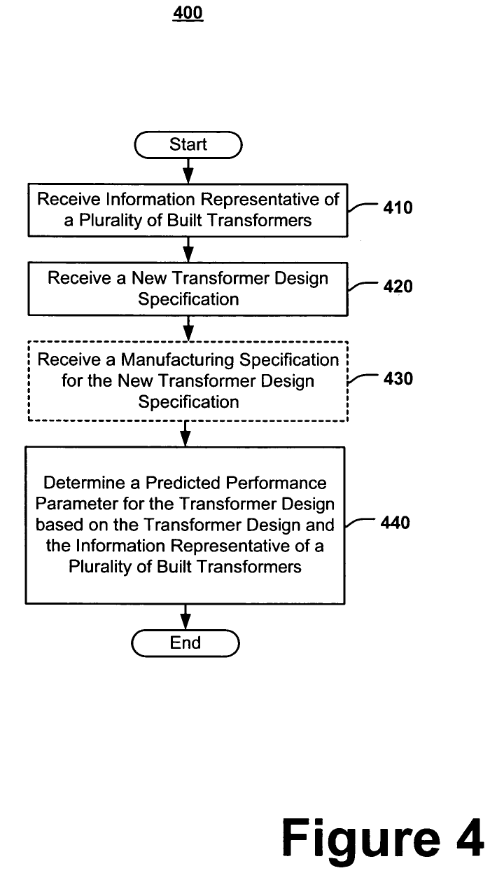

FIG. 4 shows a flow chart of an illustrative method 400 for predicting transformer performance. While the following description includes references to system 300 of FIG. 3 and computing system 120 of FIG. 1, the method may be implemented in a variety of ways, such as, for example, by a single computing engine, by multiple computing engines, via a standalone computing system, via a networked computing system, and the like.

As shown in FIG. 4, at step 410, intelligent system 310 receives information representative of a plurality of built transformers. Intelligent system 310 may receive built transformer design specification information 350, built transformer as-built information 360, built transformer measured test information 370, and built transformer manufacture information 380. The information includes information about a plurality of built transformers. The built transformers may be of different designs, may be of different power ratings, may have been built in different manufacturing plants, may have been built using different manufacturing equipment, may have been built using different materials, and the like. The information 350-380 may be pre-assembled into a database for access by intelligent system 310. The information 350-380 may be appended with information from each newly built transformer.

At step 420, intelligent system 310 may receive a transformer design specification from a user interface, such as, for example, interface and processing unit 120a″, browsers 260-262, and the like. The manufacturing specification represents design parameters that are to be applied to the transformer. The transformer design specification may include design specifications such as, for example, a specification of a conductor, a specification of a core, and the like.

At optional step 430, intelligent system 310 may receive a transformer manufacturing specification for the transformer from a user interface, such as, for example, interface and processing unit 120a″, browsers 260-262, and the like. The manufacturing specification represents manufacturing parameters that are to be applied to the transformer. For example, the transformer manufacturing specification may include a specification that the designed transformer is to be built in a particular manufacturing plant, with a particular piece of manufacturing equipment, and the like.

At step 440, intelligent system 310 determines a predicted performance parameter based on the transformer design specification received at step 420 and the information representative of a plurality of built transformers received at step 410. If a manufacture specification is received at step 430, then at step 440, intelligent system 310 determines the predicted performance parameter based on the transformer design specification received at step 420, the information representative of a plurality of built transformers received at step 410, and the manufacture specification received at step 430.

As such, a user can perform “what-if” analysis on different transformer designs and determine the effect of building the power transformer at different manufacturing plants, on different manufacturing machines, with different manufacturing equipment calibration dates, and the like. The user can also determine and distinguish between manufacturing-related variances and design-related variances. As can be seen, the above described systems and methods provide a technique for predicting power transformer performance parameters. As such, a transformer manufacturer may more efficiently design and manufacture power transformers.

Program code (i.e., instructions) for performing the above-described methods may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer, the machine becomes an apparatus for practicing the invention. The invention may also be embodied in the form of program code that is transmitted over some transmission medium, such as over electrical wiring or cabling, through fiber optics, over a network, including the Internet or an intranet, or via any other form of transmission, wherein, when the program code is received and loaded into and executed by a machine, such as a computer, the machine becomes an apparatus for practicing the above-described processes. When implemented on a general-purpose processor, the program code combines with the processor to provide an apparatus that operates analogously to specific logic circuits.

It is noted that the foregoing description has been provided merely for the purpose of explanation and is not to be construed as limiting of the invention. While the invention has been described with reference to illustrative embodiments, it is understood that the words which have been used herein are words of description and illustration, rather than words of limitation. Further, although the invention has been described herein with reference to particular structure, methods, and embodiments, the invention is not intended to be limited to the particulars disclosed herein; rather, the invention extends to all structures, methods and uses that are within the scope of the appended claims. Those skilled in the art, having the benefit of the teachings of this specification, may effect numerous modifications thereto and changes may be made without departing from the scope and spirit of the invention, as defined by the appended claims.

1. A method for predicting transformer performance, comprising:
receiving information representative of a plurality of built transformers, the information comprising a design specification for each built transformer, and measured test information for each built transformer;
receiving a second transformer design specification; and
determining, via an intelligent system, a predicted test result for the second transformer design specification based on the second transformer design specification and the information representative of the plurality of built transformers.

2. The method as recited in claim 1, wherein the intelligent system comprises a neural network.

3. The method as recited in claim 1, wherein the intelligent system comprises a genetic algorithm.

4. The method as recited in claim 1, wherein the intelligent system comprises fuzzy logic.

5. The method as recited in claim 1, wherein receiving the second transformer design specification comprises receiving, from a user interface, the second transformer design specification.

6. The method as recited in claim 1, wherein the information representative of a plurality of built transformers further comprises manufacture information for each built transformer.

7. The method as recited in claim 6, wherein the manufacture information for each built transformer comprises at least one of the group of an indication of a manufacturing plant associated with the built transformer, an indication of a piece of manufacturing equipment associated with the built transformer, an indication of a calibration date of manufacturing equipment associated with the built transformer, and an indication of a retooling date of manufacturing equipment associated with the built transformer.

8. The method as recited in claim 1, wherein the information representative of a plurality of built transformers further comprises as-built information for each built transformer.

9. The method as recited in claim 1, wherein the measured test information for each built transformer comprises at least one of the group of measured transformer load loss, measured transformer impedance, measured transformer ratio, measured transformer turn-to-turn faults, measured transformer high-potential test results, measured transformer double induced test results, measured transformer impulse test results, measured transformer heat run test results, measured transformer sound level, and measured transformer short circuit test results.

10. The method as recited in claim 1, wherein determining the predicted test result comprises determining the predicted test result without using a model based on theoretical relationships.

11. The method as recited in claim 1, further comprising:
receiving a manufacturing specification for the second transformer design; and wherein
determining the predicted result comprises determining, via an intelligent system, a predicted test result for the second transformer design specification based on the second transformer design specification, the information representative of the plurality of built transformers, and the manufacturing specification for the second transformer design.

12. A system for predicting transformer performance, comprising:
a data store comprising information representative of a plurality of built transformers, the information comprising a design specification for each built transformer and measured test information for each built transformer; and
an intelligent system in communication with the data store, the intelligent system configured to perform:
receiving a second transformer design specification; and
determining a predicted test result for the transformer design based on the second transformer design specification and the information representative of the plurality of built transformers.

13. The system as recited in claim 12, wherein the intelligent system comprises a neural network.

14. The system as recited in claim 12, wherein the intelligent system comprises a genetic algorithm.

15. The system as recited in claim 12, wherein the intelligent system comprises fuzzy logic.

16. The system as recited in claim 12, further comprising a user interface in communication with the intelligent system that receives the second transformer design specification.

17. The system as recited in claim 12, wherein the information representative of a plurality of built transformers further comprises manufacture information for each built transformer.

18. The system as recited in claim 17, wherein the manufacture information for each built transformer comprises at least one of the group of an indication of a manufacturing plant associated with the built transformer, an indication of a piece of manufacturing equipment associated with the built transformer, an indication of a calibration date of manufacturing equipment associated with the built transformer, and an indication of a retooling date of manufacturing equipment associated with the built transformer.

19. The system as recited in claim 12, wherein the information representative of a plurality of built transformers further comprises as-built information for each built transformer.

20. The system as recited in claim 12, wherein the measured test information for each built transformer comprises at least one of the group of measured transformer load loss, measured transformer impedance, measured transformer ratio, measured transformer turn-to-turn faults, measured transformer high-potential test results, measured transformer double induced test results, measured transformer impulse test results, measured transformer heat run test results, measured transformer sound level, and measured transformer short circuit test results.

21. The system as recited in claim 12, wherein determining the predicted test result comprises determining the predicted test result without using a model based on theoretical relationships.

22. The system as recited in claim 12, the intelligent system is further configured to perform:
receiving a manufacturing specification for the second transformer design; and wherein
determining the predicted result comprises determining a predicted test result for the second transformer design specification based on the second transformer design specification, the information representative of the plurality of built transformers, and the manufacturing specification for the second transformer design.
